(19) United States
(12) Patent Application Publication
(10) Pub. No.: US 2006/0022828 A1
(43) Pub. Date: Feb. 2, 2006

(54) Sticker-type shoplifting-prevention security device

(76) Inventors: Lionel Prat, Abbesses (FR); Patrice Coupin, Rond Point (FR)

Correspondence Address: YOUNG & THOMPSON, 745 SOUTH 23RD STREET, 2ND FLOOR, ARLINGTON, VA, 22202, US

(21) Appl. No.: 10/537,675

(22) PCT Filed: Nov. 21, 2003
(86) PCT No.: PCT/FR03/03454

§ 371 Date: Jun. 6, 2005

(30) Foreign Application Priority Data
Dec. 6, 2002 (FR) 0215406

(51) Int. Cl. G08B 13/14

(52) U.S. Cl. 340/572.3; 340/572.5

(57) ABSTRACT

A shoplifting-prevention security device includes a flexible flat substrate (1) having an inductor (2) and a capacitor (3) which form a resonant circuit, the plates of the capacitor being separated by a layer of dielectric material. Moreover, at least one zone (A) of the material can be used to establish a short circuit between the plates in order to deactivate the device. In addition, at least one face of the above-mentioned substrate is provided with a rigid part (B) having a contour (Bc) which surrounds the zone(s) (A) provided for the purpose of deactivation.

The invention pertains to a security device for preventing shoplifting consisting of a flexible flat substrate comprising an inductor and a capacitor which form a resonant circuit, the plates of the capacitor being separated by a layer of dielectric material at least one zone of which is designed to make it possible to establish a short-circuit between the plates for a deactivation of the device.

A security device of this kind very often takes the form of a sticker, for example square or rectangular, of a reduced thickness, of the order of a few tenths of a millimeter. This supple security device is designed to be integrated in an invisible manner into products or objects displayed for sale on shop shelves.

In particular, such security devices are used as antitheft protection for shoes and are inserted between two layers of the sole.

When the security device has not been deactivated, the resonant circuit formed by the capacitor and the inductor is in the operating state. When an object fitted with the device passes through the field of action of a detection apparatus, an alarm is triggered.

On the other hand, when the security device has been deactivated, for example at the time of payment for the object, the consumer can cross the zone of action of the detection apparatuses without causing triggering.

The deactivation of the security device is generally obtained by subjecting it to a pulsed emission which, in the zone or zones provided for this purpose of the dielectric layer, causes the establishment of a short-circuit between the plates of the capacitor so that the resonant circuit is no longer operative.

However, it is apparent that such deactivation does not exhibit sufficient reliability. In particular, in the case of shoes, the short-circuit effected by the electrical link between the plates of the capacitor may disappear through breakage of this electrical link when the consumer walks with the shoes. The zone of the sole where the security device is located is in fact subjected to repeated bendings that may provoke the breakage of the electrical link. In the case of such a breakage, the consumer having properly purchased the shoes that he is wearing will trigger an alarm on entering a shop equipped with a detection device for preventing shoplifting. Such untoward triggering is a source of unjustified nuisance for the consumer and should be avoided.

The example has been provided in relation to shoes, but it is clear that other objects or products, equipped with stickers of the kind in question, may be involved.

The invention is therefore aimed above all, at providing a security device for preventing shoplifting which no longer exhibits, or exhibits to a lesser degree, the drawbacks mentioned above, and which makes it possible to obtain reliable deactivation of the device, while remaining simple and economical.

According to the invention, a security device for preventing shoplifting, of the sticker type, as defined previously is characterized in that on one face at least of the substrate is provided a rigidified part whose contour surrounds the zone or zones provided for deactivation.

A rigidified part may be provided on each face of the substrate, the contour of each rigidified part surrounding the zone or zones provided for deactivation.

The rigidity of the rigidified part is such that the repeated bending movements of the flexible substrate are prevented or limited in the zone or zones where the short-circuits have been, or will be, established. The electrical short-circuit links are thus protected against breakage.

The rigidified part may be constituted by a region of the substrate itself having undergone a rigidification treatment or having a specific composition endowing it with greater rigidity, or by an add-on rigidification element fixed to the substrate.

The add-on rigidification element may be made of resin, or of composite resin hardened when cold or under ultraviolet radiation.

The rigidification element may also be constituted by a ring or a rigid panel, for example made of metal or insulating material, in particular hard plastic. The panel may be flat, or domed, possibly pierced at its center. The ring or the panel may be honed on its periphery.

Preferably, a rigidification element is fixed on each face of the flat element, on either side of the zone or zones provided for deactivation.

Advantageously, the sticker has a contour of ovoid form with one end narrower than the other, and the capacitor plates are provided toward the narrower end. Such a sticker may be inserted into the toe of the sole of a shoe, in front of the zone of natural creasing when walking; the sticker is then less stressed in bending and the risk of undesired reactivation is yet more reduced. The detection and the incorporation into the shoe are optimized, and a guard distance, preferably of at least 2 cm (two centimeters), is preserved between the edge of the sticker and the edge of the shoe, for gluing between insole and sole.

The invention consists, apart from the provisions set forth hereinabove, of a certain number of other provisions that will be dealt with more explicitly hereinafter in relation to exemplary embodiments described in detail with reference to the appended drawings, but which are in no way limiting.

In these drawings:

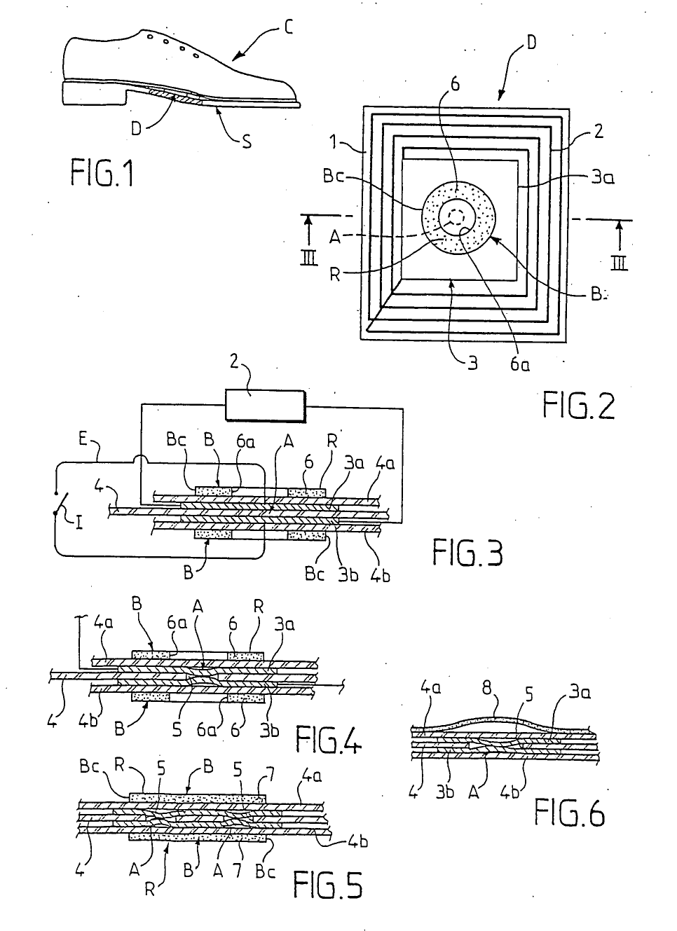

FIG. 1 is a diagrammatic view, with cutaway part, of a shoe whose sole is equipped with a security device for preventing shoplifting.

FIG. 2 is a plan view on a larger scale of the security device according to the invention.

FIG. 3 is a partial diagrammatic vertical section on a larger scale, along the line III-III of FIG. 2, showing the device zone provided for deactivation before punching.

FIG. 4 shows, similarly to FIG. 3, the zone after punching.

FIG. 5 and 6 are diagrammatic sections of variant embodiments.

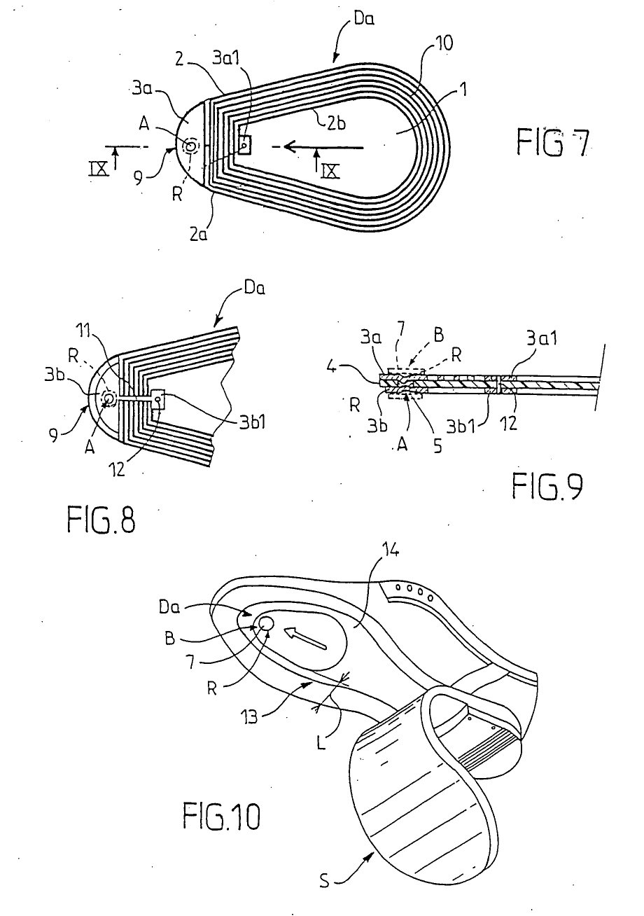

FIG. 7 is a plan view of a variant embodiment of the sticker.

FIG. 8 is a partial view from below of FIG. 7.

FIG. 9 is a diagrammatic partial section on a larger scale along the line IX-IX of FIG. 7, and

FIG. 10 is a perspective view, on a smaller scale, of a shoe sole where the sticker of FIG. 7 is currently being installed.

Referring to FIG. 1, there may be seen a shoe C furnished with a security device D for preventing shoplifting. The device D of the sticker type is inserted and glued between two layers of the sole S of the shoe. The thickness of the device D is small, a few tenths of a millimeter, so that its presence in the sole is not inconvenient and is not perceptible.

Of course, products other than shoes may be equipped in the same manner, for example books or clothes.

As visible in FIG. 2, the device D consists of a flat flexible substrate 1, for example square with a side of a few centimeters, in particular of the order of 5 cm. The substrate is advantageously constituted of a multilayer flexible film of plastic and aluminum. The device D comprises an inductor 2 formed by flat conducting segments of aluminum disposed along square or rectangular contours, parallel to the edges of the sticker, between two layers of plastic. The device D furthermore comprises a capacitor 3 having flat plates 3a, 3b formed by metallic or aluminum-metallized surfaces, provided on either side of a sheet 4 of insulating plastic forming a dielectric layer. In the example of FIG. 2 the plates 3a, 3b are formed by square surfaces surrounded by the conductors of the inductor 2 which is linked in parallel, as illustrated diagrammatically in FIG. 3, to the plates 3a, 3b of the capacitor. The plates 3a, 3b are covered by an adhesive sheet of plastic 4a, 4b.

At least one zone A is provided in the dielectric layer 4 so as to make it possible to establish a short-circuit between the plates 3a, 3b when the device D is subjected to a pulsed high-frequency emission produced by a deactivation apparatus. The zone A, in the example of FIG. 2, is situated at the center of the plates 3a, 3b and comprises a hole 5 (FIG. 4) in the layer 4. This hole 5 is formed during a punching of the plates 3a, 3b of the capacitor so as to place them in mechanical contact as illustrated in FIG. 4, but without establishing an electrical contact by reason of the insulating layer constituted by the layer of aluminum oxide present on the surface of the plates. As appropriate, a fusible material may be provided in a part of the zone A, without being in contact with the two plates.

When the device D is subjected to the deactivation apparatus, heating and deoxidation occur in the zone A; the plates 3a, 3b weld together, with establishment of an electrical micro-contact and a short-circuit is established between them. In FIG. 3 the deactivation apparatus has been shown diagrammatically in the form of an electrical circuit E wired up to the plates; the circuit E comprises a breaker whose closure symbolizes the actioning of the pulsed emission causing the micro-welding of the plates 3a, 3b and the short-circuit.

According to the invention, at least one face of the substrate 1 comprises a rigidified part B whose contour Bc surrounds the zone A provided for deactivation. Preferably a rigidified part B such as this is provided on each face of the flat element 1 so as to surround the zone A.

The rigidified part B constitutes a rigid protection provided so as to ensure sufficient mechanical retention of the region surrounding the zone A in order to avoid bendings of this zone that are liable to cause the breakage of the electrical link after deactivation.

The part B may be constituted by a region of the substrate itself having undergone a rigidification treatment or having a specific composition endowing it with greater rigidity, or by an add-on rigidification element R fixed to the substrate.

The fixing of the rigidification element R to the element 1 is generally carried out by gluing so that the substrate 1 region situated inside the contour of the rigidification element R undergoes no stretching when the device D is subjected to bendings.

The rigidification element R may be made of resin, or of composite resin hardened when cold or under ultraviolet radiation.

Other examples of materials that are rigid enough to embody the element R comprise metallic materials, hard plastics, carbon, ceramic or composite materials. The thickness of the element R is small, of the order of a few tenths of a millimeter, for example 5/10ths of a millimeter.

The rigidification element R may have the form of a ring or of a metallic or insulating panel, flat or domed and/or honed on its periphery.

In the example of FIG. 2, the element R is constituted by a rigid ring 6 centered on the zone A. The inside contour 6a of the ring surrounds the zone A. It is thus apparent that the region of the layer 4 comprising the zone A is retained by the ring 6 and will not be subjected to bending movements.

The inside diameter and the outside diameter of the ring 6 are chosen in such a way as to ensure sufficient mechanical retention of the zone A. In the nonlimiting exemplary embodiment of FIG. 2, the inside diameter of the ring is around 1 cm and the outside diameter is around 2 cm.

The element R may also be constituted by a flat panel 7 as illustrated in FIG. 5. In this variant, two zones A for the establishment of a short-circuit are provided in the layer 4. The contour of the panel 7 may be polygonal, in particular square, or circular.

FIG. 6 shows another variant embodiment according to which the rigid protection panel 8 is domed, convex outward. The contour of the panel 8 surrounds the zone A and is fixed by gluing to the element 1. The domed part, distanced from the substrate 1, endows the panel 8 with good rigidity. According to the example of FIG. 6 a single panel 8 is provided on a face of the element 1. Of course it would be possible to provide two domed panels, one on each face.

FIGS. 7 to 10 relate to another variant of the device in the form of a sticker Da. This variant is especially advantageous for the insertion into a shoe sole. The sticker Da exhibits an ovoid contour with one end 9 narrower than the other end 10. The plates 3a and 3b of the capacitor are provided at the narrower end 9.

The inductor 2, as visible in FIG. 7, is constituted by a winding of narrow conducting strips parallel to the contour of the substrate 1. The plate 3a of the capacitor, in the form of a sector of a circle, situated on a face of the substrate is linked to the outside strip 2a of the inductor. The inside strip 2b is linked electrically to a metallized surface, for example rectangular 3a1.

The other face of the substrate 1 comprises at the front a sector of a circle forming the plate 3b of the capacitor which is linked electrically by a conducting strip 11, substantially along the longitudinal axis of the substrate 1, to a metallized surface 3b1 in line with the surface 3a1. The surface 3b1 is linked electrically to the surface 3a1 through a hole 12 in the sheet 4.

The rigidification element R constituted by a ring 7 is disposed against the metallized surfaces 3a, 3b.

This sticker Da of ovoid form may be inserted toward the front of the sole of the shoe as illustrated in FIG. 10 while preserving a strip 13 having a width L of at least 2 cm for the gluing between the insole 14 and the sole S, toward the outside. The zone subjected to deactivation is situated on the plates 3a, 3b of the capacitor. This zone is located at the toe of the shoe, in front of the zone of natural creasing of the sole when walking. As a result, the elements involved in deactivation are less stressed in bending and the risk of deactivation is reduced.

The sticker Da of ovoid form optimizes the detection and the incorporation into the shoe.

The security device of the invention with the rigidification element R makes it possible to obtain dependable and permanent neutralization of antitheft protection by preventing the breakage of the short-circuit established between the plates 3a, 3b of the capacitor during deactivation.

The electrical contact or contacts establishing the short-circuit are protected by the rigidification element R against rubbing and movements, thereby preventing any risk of reactivation by breakage of the electrical link, in particular when the device D is used in a shoe sole.

The rigidification element R furthermore ensures protection of the capacitor against possible impairment by chemical products.

1. A security device for preventing shoplifting consisting of a flexible flat substrate (1) comprising an inductor (2) and a capacitor (3) which form a resonant circuit, the plates (3a, 3b) of the capacitor being separated by a layer (4) of dielectric material at least one zone (A) of which is designed to make it possible to establish a short-circuit between the plates (3a, 3b) for a deactivation of the device,
characterized in that on one face at least of the substrate is provided a rigidified part (B) whose contour (Bc) surrounds the zone or zones (A) provided for deactivation.

2. The device as claimed in claim 1, characterized in that a rigidified part (B) is provided on each face of the substrate (1), the contour of each rigidified part surrounding the zone or zones (A) provided for deactivation.

3. The device as claimed in claim 1, characterized in that the rigidity of the rigidified part (B) is such that the repeated bending movements of the flexible substrate (1) are prevented or limited in the zone or zones (A) where the short-circuits have been, or will be, established.

4. The device as claimed in claim 1, characterized in that the rigidified part (B) is constituted by a region of the substrate (1) itself having undergone a rigidification treatment or having a specific composition endowing it with greater rigidity.

5. The device as claimed in claim 1, characterized in that the rigidified part (B) is constituted by an add-on rigidification element (R) fixed to the substrate (1).

6. The device as claimed in claim 5, characterized in that the rigidification element (R) is made of resin, or of composite resin hardened when cold or under ultraviolet radiation.

7. The device as claimed in claim 5, characterized in that the rigidification element (R) is metallic.

8. The device as claimed in claim 5, characterized in that the rigidification element (R) is constituted by a ring (6).

9. The device as claimed in claim 5, characterized in that the rigidification element (R) is constituted by a flat (7) or domed (8) rigid panel.

10. The device as claimed in claim 1, characterized in that it comprises a sticker (Da) having a contour of ovoid form with one end (9) narrower than the other (10), the capacitor plates (3a; 3b) being provided toward the narrower end (9), such a sticker (Da) being insertable into the toe of the sole of a shoe, in front of the zone of natural creasing when walking.

11. The device as claimed in claim 2, characterized in that the rigidity of the rigidified part (B) is such that the repeated bending movements of the flexible substrate (1) are prevented or limited in the zone or zones (A) where the short-circuits have been, or will be, established.

12. The device as claimed in claim 2, characterized in that the rigidified part (B) is constituted by a region of the substrate (1) itself having undergone a rigidification treatment or having a specific composition endowing it with greater rigidity.

13. The device as claimed in claim 3, characterized in that the rigidified part (B) is constituted by a region of the substrate (1) itself having undergone a rigidification treatment or having a specific composition endowing it with greater rigidity.

14. The device as claimed in claim 2, characterized in that the rigidified part (B) is constituted by an add-on rigidification element (R) fixed to the substrate (1).

15. The device as claimed in claim 3, characterized in that the rigidified part (B) is constituted by an add-on rigidification element (R) fixed to the substrate (1).

16. The device as claimed in claim 6, characterized in that the rigidification element (R) is constituted by a ring (6).

17. The device as claimed in claim 7, characterized in that the rigidification element (R) is constituted by a ring (6).

18. The device as claimed in claim 6, characterized in that the rigidification element (R) is constituted by a flat (7) or domed (8) rigid panel.

19. The device as claimed in claim 7, characterized in that the rigidification element (R) is constituted by a flat (7) or domed (8) rigid panel.
